(19) United States
(12) Patent Application Publication
(10) Pub. No.: US 2011/0131533 A1
(43) Pub. Date: Jun. 2, 2011

(54) APPARATUS AND METHOD FOR USER INTERFACE CONFIGURATION IN PORTABLE TERMINAL

(75) Inventor: Han-Jun KU, Suwon-si (KR)

(73) Assignee: SAMSUNG ELECTRONICS CO. LTD., Suwon-si (KR)

(21) Appl. No.: 12/950,034

(22) Filed: Nov. 19, 2010

(30) Foreign Application Priority Data
Nov. 27, 2009 (KR) 10-2009-0115593

(51) Int. Cl. G06F 3/048

(52) U.S. Cl. 715/836

(57) ABSTRACT

An apparatus and a method for managing a menu icon on one screen in a portable terminal are provided. The method includes selecting a menu icon through a screen touch input of a user, rotating a sphere displayed on the screen according to the touch input of the user, selecting a sphere region, into which the menu icon is to move, through a screen touch input of the user, and moving the selected menu icon to the selected sphere region.

### PRIORITY

This application claims the benefit under 35 U.S.C. §119 of a Korean patent application filed in the Korean Intellectual Property Office on Nov. 27, 2009 and assigned Serial No. 10-2009-0115593, the entire disclosure of which is incorporated herein by reference.

### BACKGROUND OF THE INVENTION

1. Field of the Invention

The present invention relates to user interface menu configuration in a portable terminal. More particularly, the present invention relates to an apparatus and method for managing a menu icon on one screen of a portable terminal.

2. Description of the Related Art

In general, a user menu in a portable terminal uses a uniform icon of a fixed size to display each menu, and icons are located on a page-by-page basis with an increase in the number of menus. The pages are grouped according to menu characters and can be changed by the user.

When the user moves an icon in the user menu on a page-by-page basis, the user moves the icon by using a sweep operation after entering an edit mode.

Such a user menu may fail to conform to users' expectations due to the uniform icon arrangement. Also, the number of pages increases with an increase in the number of menus. This makes movement of a menu icon difficult when the user moves to another page in the user menu.

In addition, an edit mode is essential because the user must use an edit mode when moving a menu icon.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for user interface menu configuration in a portable terminal.

Another aspect of the present invention is to provide an apparatus and method for moving a menu icon to another page in a portable terminal more easily despite an increase in the number of pages.

Another aspect of the present invention is to provide an apparatus and method for processing menu execution and menu icon movement on a screen in a portable terminal without using an additional edit mode.

According to an aspect of the present invention, a method for managing a menu icon on one screen in a portable terminal is provided. The method includes, selecting a menu icon through a screen touch input of a user, rotating a sphere displayed on the screen according to the touch input of the user, selecting a sphere region, into which the menu icon is to move, through a screen touch input of the user, and moving the selected menu icon to the selected sphere region.

According to another aspect of the present invention, a method for managing a menu icon on one screen in a portable terminal is provided. The method includes, selecting a menu icon through a screen touch input of a user, moving the selected menu icon to the outside of a sphere displayed on the screen according to the touch input of the user, rotating the sphere displayed on the screen according to the touch input of the user, selecting a sphere region, into which the menu icon is to move, through a screen touch input of the user, and moving the selected menu icon to the selected sphere region.

According to another aspect of the present invention, an apparatus for managing a menu icon on one screen in a portable terminal is provided. The apparatus includes, a display unit for providing a screen display, and a menu setting unit for selecting a menu icon through a screen touch input of a user, for rotating a sphere displayed on the screen according to the touch input of the user, for selecting a sphere region, into which the menu icon is to move, through a screen touch input of the user, and for moving the selected menu icon to the selected sphere region.

According to another aspect of the present invention, an apparatus for managing a menu icon on one screen in a portable terminal is provided. The apparatus includes, a display unit for providing a screen display, and a menu setting unit for selecting a menu icon through a screen touch input of a user, for moving the selected menu icon to the outside of a sphere displayed on the screen according to the touch input of the user, for rotating the sphere displayed on the screen according to the touch input of the user, for selecting a sphere region, into which the menu icon is to move, through a screen touch input of the user, and for moving the selected menu icon to the selected sphere region.

According to another aspect of the present invention, a method for displaying a menu icon on one screen of a portable terminal is provided. The method includes, determining whether a region is selected from a sphere of a first screen portion, and displaying, if the region is selected, at least one menu icon included in the selected region in a second screen portion.

According to another aspect of the present invention, an apparatus for displaying a menu icon on one screen of a portable terminal is provided. The apparatus includes, a display unit for providing a screen display, and a menu setting unit for determining whether a region is selected from a sphere of a first screen portion, and for displaying, if the region is selected, at least one menu icon included in the selected region in a second screen portion.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a portable terminal using a user menu according to an exemplary embodiment of the present invention;

FIG. 2 is a flow diagram illustrating a user menu setting and using process in a portable terminal according to an exemplary embodiment of the present invention;

FIG. 3 is a flow diagram illustrating an operation process for performing all functions on one screen in a portable terminal according to an exemplary embodiment of the present invention;

FIG. 4 is a flow diagram illustrating a menu icon moving process according to an exemplary embodiment of the present invention;

FIG. 5 is a flow diagram illustrating a menu icon moving process according to an exemplary embodiment of the present invention; and

FIG. 6 is a block diagram of a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and method for user interface menu configuration in a portable terminal.

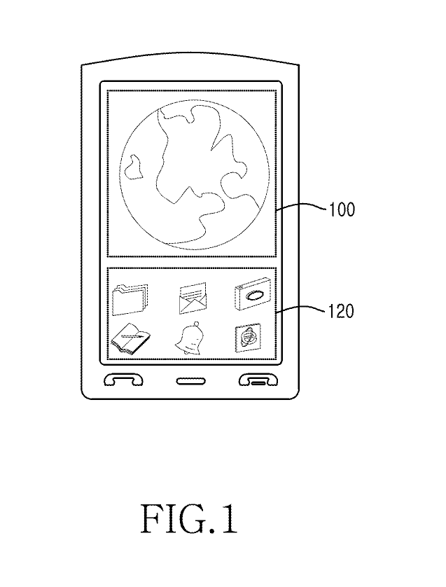

FIG. 1 is a diagram illustrating a portable terminal using a user menu according to an exemplary embodiment of the present invention.

Referring to FIG. 1, a top portion 100 in a portable terminal displays a sphere representing a virtual map. In the sphere, the map may be divided on a region-by-region basis. A bottom portion 120 illustrates menu icons included in an activated or selected region in the map. According to an activated or selected region in the top portion 100, a menu icon of the bottom portion 120 is changed and displayed.

A user may touch and hold or sweep the sphere of the top portion 100 to rotate the sphere to display a desired region. When the desired region is selected or activated, the menu icons of the desired region are displayed in the bottom portion 120.

Herein, the menu icons included in the desired region are displayed in the bottom portion 120 together with the effect that the menu icons fly from the desired region of the sphere to the bottom portion 120.

If there is a menu icon that the user desires to move to another region of the sphere, the user touches and holds the menu icon and then rotates the sphere with another finger (or stylus). Thereafter, the user drags and drops the menu icon onto the desired reign, thereby moving the menu icon to the desired region (or the desired menu group).

Also, the user drags and drops a menu icon to the outside of the sphere, rotates the sphere so that a desired region (menu group) appears at the front, and drags and drops the menu icon of the outside to the desired region, thereby moving the menu icon of the outside to the desired region.

The menu icons of the bottom portion 120 may be set to a maximum number according to the screen size. If there is no restriction on the maximum number of menu icons, the user can display more menu icons than the maximum number by using a sweep function.

If the number of menu icons of the bottom portion 120 according to the screen size is smaller than the maximum number, the menu icons are managed within the maximum number. In this case, all of the menu icons can be displayed on one screen.

If the maximum number of menu icons includable in one region (or one menu group), not the screen size, is predetermined, and if a new menu icon is added from another region (or another menu group) to the region, the previous menu icons included in the region are pushed outside the sphere and the user can move the pushed menu icons to a new region.

Herein, if the user touches an empty region in the sphere, a new menu group may be generated. Also, if it is desired to write and change the name of each region corresponding to a menu icon group, the user may write and change the name of each region corresponding to the menu icon group. Also, the map of the sphere may be preset or may be edited based on the user's interest.

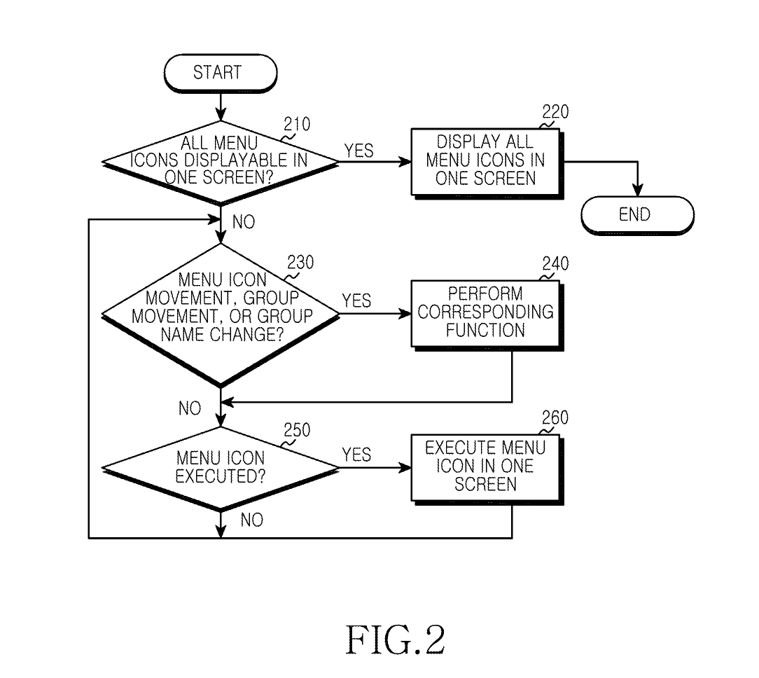

FIG. 2 is a flow diagram illustrating a user menu setting and using process in a portable terminal according to an exemplary embodiment of the present invention.

Referring to FIG. 2, if all of the menu icons in a region of the sphere can be displayed in one screen in step 210, all of the menu icons are displayed in one screen in step 220.

If all of the menu icons in a region of the sphere cannot be displayed in one screen in step 210, the user may use a sweep function to move the one or more undisplayable menu icons to another region or may move the menu icons or the corresponding groups in order to move the one or more undisplayable menu icons to another region. Then, the user may execute a group name changing function to change the group name. If the execution of such a function is requested by the user in step 230, the portable terminal performs the corresponding function in step 240.

If the execution of a menu icon is requested by the user in step 250, the portable terminal executes the corresponding menu icon in one screen in step 260.

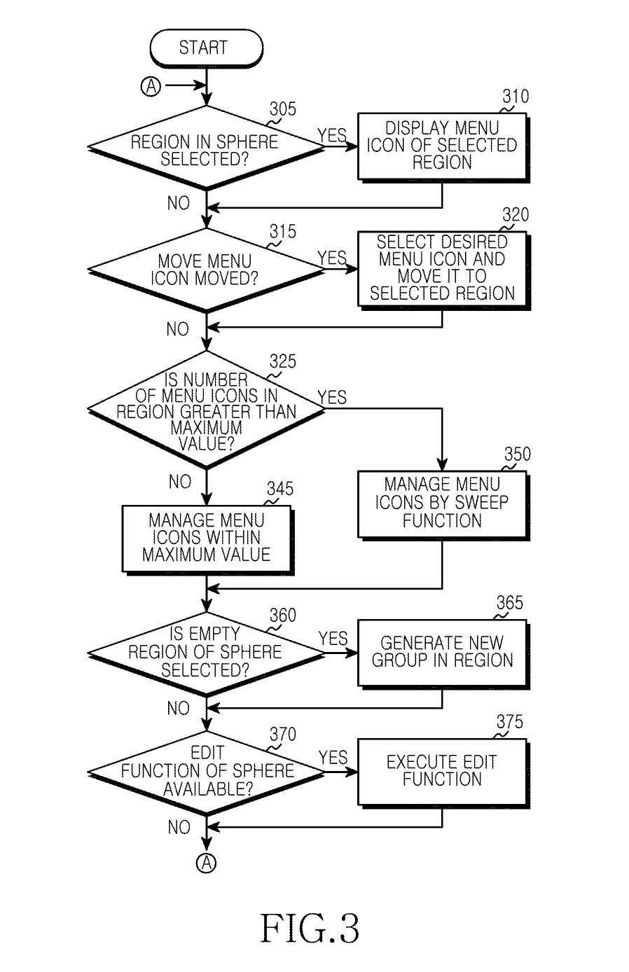

FIG. 3 is a flow diagram illustrating an operation process for performing all functions on one screen in a portable terminal according to an exemplary embodiment of the present invention.

Referring to FIG. 3, the user touches and holds or sweeps the sphere of the top portion 100 to rotate it to display a desired region. When the desired region is selected or activated in step 305, the menu icons of the desired region are displayed in the bottom portion 120 in step 310.

Herein, the menu icons included in the desired region are displayed in the bottom portion 120 together with the effect that the menu icons fly from the desired region of the sphere to the bottom portion 120.

If there is a menu icon that the user desires to move to another region of the sphere in step 315, the user touches and holds the menu icon and then rotates the sphere with another finger (or stylus). Thereafter, the user drags and drops the menu icon onto the desired reign, thereby moving the menu icon to the desired region (or the desired menu group) in step 320.

Also, the user drags and drops a menu icon to the outside of the sphere, rotates the sphere so that a desired region (menu group) appears at the front, and drags and drops the menu icon that is outside of the sphere to the desired region, thereby the user moves the menu icon that is outside of the sphere to the desired region.

The menu icons of the bottom portion 120 may be set to the maximum number according to the screen size. If there is no restriction on the maximum number of menu icons, or if the number of menu icons of the bottom portion 120 according to the screen size is greater than the maximum number in step 325, the user can display more menu icons than the maximum number by using a sweep function in step 350.

If the number of menu icons of the bottom portion 120 according to the screen size is smaller than the maximum number in step 325, the menu icons are managed within the maximum number in step 345. In this case, all of the menu icons can be displayed on one screen.

If the maximum number of menu icons that can be included in one region (or one menu group), not the screen size, is predetermined, and if a new menu icon is added from another region (or another menu group) to the region, the previous menu icons included in the region are pushed outside the sphere and the user can move the pushed menu icons to a new region.

Herein, if the user touches an empty region in the sphere in step 360, a new menu group may be generated in step 365. Also, if it is desired to write and change the name of each region corresponding to a menu icon group and an edit function is available in step 3, the user may use the edit function to write and change the name of each region corresponding to the menu icon group in step 375. Also, the map of the sphere may be preset or may be edited to attract the user's interest.

Hereinafter, a description will be given of a process for moving a menu icon from a region to another region in a portable terminal according to an exemplary embodiment of the present invention.

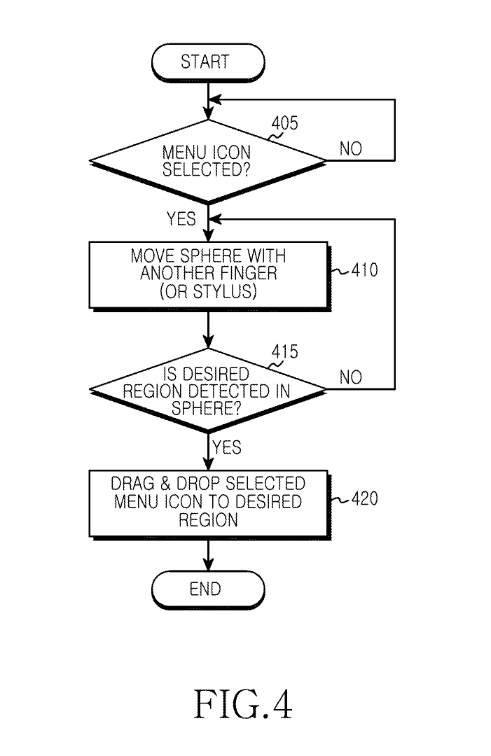

FIG. 4 is a flow diagram illustrating a menu icon moving process according to an exemplary embodiment of the present invention.

Referring to FIG. 4, if the user selects a menu icon from the bottom portion 120 in step 405, the user moves the sphere with another finger (or stylus) while selecting the menu icon in step 410.

Thereafter, if the user detects a desired region in the sphere in step 415, the user drags and drops the selected menu icon to the desired region in step 420. By this process, the selected menu icon is moved to the desired region.

Thereafter, the algorithm of the exemplary embodiment of the present invention is ended.

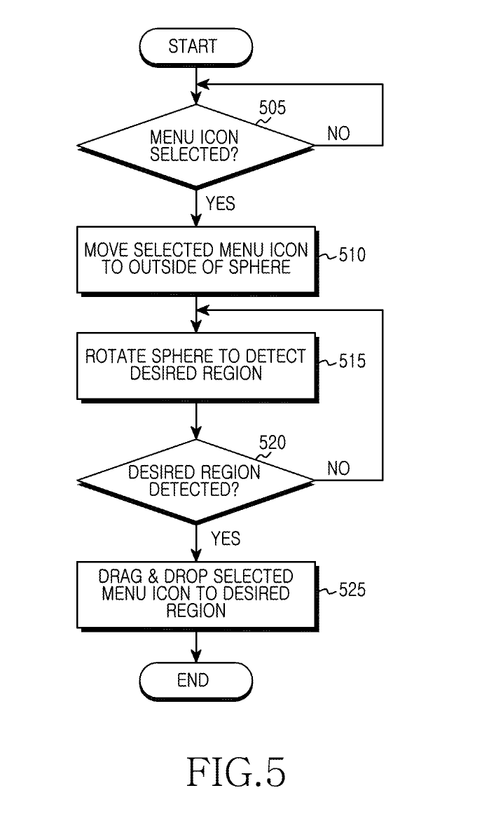

FIG. 5 is a flow diagram illustrating a menu icon moving process according to an exemplary embodiment of the present invention.

Referring to FIG. 5, if the user selects a menu icon from the bottom portion 120 in step 505, the user moves the selected menu icon to the outside of the sphere in step 510.

Thereafter, the user moves (e.g., rotates) the sphere to detect a desired region in the sphere in step 515.

Thereafter, if the user detects a desired region in the sphere in step 520, the user drags and drops the selected menu icon to the desired region in step 525. By this process, the selected menu icon is moved to the desired region.

Thereafter, the algorithm of the exemplary embodiment of the present invention is ended.

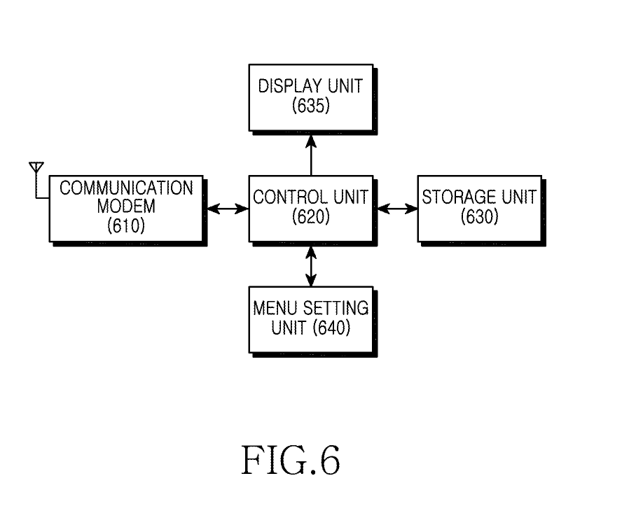

FIG. 6 is a block diagram of a portable terminal according to an exemplary embodiment of the present invention.

Referring to FIG. 6, the portable terminal includes a communication modem 610, a control unit 620, a storage unit 630, a display unit 635, and a menu setting unit 640.

The communication modem 610 is a module for communicating with another device. The communication modem 610 may include a radio processing unit and a baseband processing unit. The radio processing unit may convert a signal, received through an antenna, into a baseband signal and may provide the same to the baseband processing unit. Also, the radio processing unit may convert a baseband signal, received from the baseband processing unit, into a radio signal and may provide the same to the antenna.

The control unit 620 controls overall operations of the portable terminal. For example, the control unit 620 may perform a control operation for at least one of voice communication and packet communication. In particular, the control unit 620 may control the menu setting unit 610 according to exemplary embodiments of the present invention.

The storage unit 630 may store at least one of a program for controlling overall operations of the portable terminal, and temporary data generated during the execution of the program. In particular, according to an exemplary embodiment of the present invention, the storage unit 630 may store information about the position of a region in the sphere and menu icons in the region.

The display unit 635 may display data outputted from the control unit 620. According to an exemplary embodiment of the present invention, at least one of the sphere of the top portion 100 and the menu icons of the bottom portion 120 may be displayed on the screen of the display unit 635. Although not illustrated in the drawings, the display unit 635 may be provided with a touch function, and input touch data may be provided to the control unit 620.

While the user touches and holds or sweeps the sphere of the top portion 100, displayed in the display unit 635, in order to rotate the sphere so as to display a desired region, the menu setting unit 640 rotates the sphere. Thereafter, when the desired region is selected or activated by the user, the menu setting unit 640 may display the menu icons of the desired region in the bottom portion 120 of the display unit 635.

Herein, the menu setting unit 640 may display the menu icons included in the desired region in the bottom portion 120 together with the effect that the menu icons fly from the desired region of the sphere to the bottom portion 120.

When the user rotates the sphere, the menu setting unit 640 may receive data, which is inputted through a touch function of the display unit 635, through the control unit 620, may analyze the received data, and may display the rotating sphere in the display unit 635.

Also, when the user selects a region in the sphere, the menu setting unit 640 may detect the menu icons included in the selected region from the storage unit 630 and may display the same in the bottom portion 120 of the display unit 635.

By the function of the menu setting unit 640, the user may touch and hold the menu icon, may rotate the sphere with another finger (or stylus), and may drag and drop the menu icon onto the desired reign. Then, the menu setting unit 640 may move the menu icon to the desired region (or the desired menu group).

Also, by the function of the menu setting unit 640, the user may drag and drop a menu icon to the outside of the sphere, may rotate the sphere so that a desired region (menu group) appears at the front, and may drag and drop the menu icon of the outside of the sphere to the desired region, thereby moving the menu icon of the outside of the sphere to the desired region.

The menu setting unit 640 may set the menu icons of the bottom portion 120 to the maximum number according to the screen size. If there is no restriction on the maximum number of menu icons, the user may use a sweep function through the function of the menu setting unit 640. Thereby, the menu setting unit 640 may then display more menu icons than the maximum number.

If the number of menu icons of the bottom portion 120 according to the screen size is smaller than the maximum number, the menu setting unit 640 may manage the menu icons within the maximum number. In this case, the menu setting unit 640 may display all of the menu icons on one screen.

If the maximum number of menu icons that can be included in one region (or one menu group), not the screen size, is predetermined, and if a new menu icon is added from another region (or another menu group) to the region, the menu setting unit 640 may push the previous menu icons included in the region outside the sphere and the user may use the function of the menu setting unit 640 to move the pushed menu icons to a new region.

Herein, if the user touches an empty region in the sphere, the menu setting unit 640 may generate a new menu group. Also, if it is desired to write and change the name of each region corresponding to a menu icon group, the user may use the function of the menu setting unit 640 to write and change the name of each region corresponding to the menu icon group. Also, the menu setting unit 640 may preset the map of the sphere or may provide an edit function based on the user's desires.

Those skilled in the art will understand that the functionality associated with the control unit 620 may be centralized or distributed, whether locally or remotely. For example, the control unit 620 may be configured to also perform the functions of the menu setting unit 640.

According to exemplary embodiments of the present invention, the control unit 620 may be configured to also perform all or some of the functions of the menu setting unit 640.

Unlike the conventional method, the embodiments of the present invention do not need an additional edit mode and do not require an additional action of the user due to an increase in the number of pages. The exemplary embodiments of the present invention can process all operations in one screen, thus making it possible to provide a convenience and an intuitive user interface to the user.

Also, the exemplary embodiments of the present invention can perform an order change and a group movement in one screen and can intuitively display a menu icon group, thus making it possible for the user to easily search the menu icon group.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for managing a menu icon on one screen in a portable terminal, the method comprising:
selecting, by a menu setting unit, a menu icon through a screen touch input of a user;
rotating, by the menu setting unit, a sphere displayed on the screen according to the touch input of the user;
selecting, by the menu setting unit, a sphere region, into which the menu icon is to move, through a screen touch input of the user; and
moving, by the menu setting unit, the selected menu icon to the selected sphere region.

2. The method of claim 1, further comprising, before the selecting of the menu icon through the screen touch input of the user:
selecting, by the menu setting unit, the sphere region including the selected menu icon through the touch input of the user in the sphere displayed on the screen; and
displaying, by a display unit, at least one menu icon included in the sphere region including the selected menu icon on the screen.

3. The method of claim 2, wherein the displaying of the at least one menu icon included in the sphere region including the selected menu icon on the screen comprises:
displaying the at least one menu icon on the screen together with the effect that the menu icon flies from the sphere displayed on the screen.

4. The method of claim 1, further comprising, after the moving of the selected menu icon to the selected sphere region:
displaying, by a display unit, the moved menu icon on the screen.

5. The method of claim 4, wherein the displaying of the moved menu icon on the screen comprises:
displaying the menu icon on the screen together with the effect that the menu icon flies from the sphere displayed on the screen.

6. The method of claim 1, further comprising:
generating, by the menu setting unit, a new region if the user touches an empty region in the sphere displayed on the screen.

7. The method of claim 1, further comprising:
providing, by the menu setting unit, an edit function for at least one of menu generation, menu change and menu deletion if the user requests one of menu generation, menu change and menu deletion with respect to a region of the sphere; and
executing, by the menu setting unit, the menu icon if the user requests the execution of the menu icon.

8. The method of claim 1, further comprising:
displaying, by a display unit, the menu icon included in the sphere region by using a sweep function if the number of menu icons included in the sphere region is greater than the maximum number of menu icons displayable on one screen.

9. The method of claim 1, wherein the rotating of the sphere displayed on the screen according to the touch input of the user comprises:
rotating the sphere displayed on the screen according to another touch input of the user while maintaining the touch input of the user for selecting the menu icon on the screen.

10. A method for managing a menu icon on one screen in a portable terminal, the method comprising:
selecting, by a menu setting unit, a menu icon through a screen touch input of a user;
moving, by the menu setting unit, the selected menu icon to the outside of a sphere displayed on the screen according to the touch input of the user;
rotating, by the menu setting unit, the sphere displayed on the screen according to the touch input of the user;
selecting, by the menu setting unit, a sphere region, into which the menu icon is to move, through a screen touch input of the user; and
moving, by the menu setting unit, the selected menu icon to the selected sphere region.

11. The method of claim 10, further comprising, before the selecting of the menu icon through the screen touch input of the user:
selecting, by the menu setting unit, the sphere region including the selected menu icon through the touch input of the user in the sphere displayed on the screen; and
displaying, by a display unit, at least one menu icon included in the sphere region including the selected menu icon on the screen.

12. The method of claim 11, wherein the displaying of the at least one menu icon included in the sphere region including the selected menu icon on the screen comprises:
displaying the at least one menu icon on the screen together with the effect that the menu icon flies from the sphere displayed on the screen.

13. The method of claim 10, further comprising, after the moving of the selected menu icon to the selected sphere region:
displaying, by a display unit, the moved menu icon on the screen.

14. The method of claim 13, wherein the displaying of the moved menu icon on the screen comprises:
displaying the menu icon on the screen together with the effect that the menu icon flies from the sphere displayed on the screen.

15. The method of claim 10, further comprising:
generating by the menu setting unit, a new region if the user touches an empty region in the sphere displayed on the screen.

16. The method of claim 10, further comprising:
providing, by the menu setting unit, an edit function for at least one of menu generation, menu change and menu deletion if the user requests one of menu generation, menu change and menu deletion with respect to a region of the sphere; and
executing, by the menu setting unit, the menu icon if the user requests the execution of the menu icon.

17. The method of claim 10, further comprising:
displaying, by a display unit, the menu icon included in the sphere region by using a sweep function if the number of menu icons included in the sphere region is greater than the maximum number of menu icons displayable on one screen.

18. An apparatus for managing a menu icon on one screen in a portable terminal, the apparatus comprising:
a display unit for providing a screen display; and
a menu setting unit for selecting a menu icon through a screen touch input of a user, for rotating a sphere displayed on the screen according to the touch input of the user, for selecting a sphere region, into which the menu icon is to move, through a screen touch input of the user, and for moving the selected menu icon to the selected sphere region.

19. The apparatus of claim 18, wherein, before the selecting of the menu icon through the screen touch input of the user, the menu setting unit selects the sphere region including the selected menu icon through the touch input of the user in the sphere displayed on the screen, and displays at least one menu icon included in the sphere region including the selected menu icon on the screen.

20. The apparatus of claim 19, wherein the menu setting unit displays the at least one menu icon on the screen together with the effect that the menu icon flies from the sphere displayed on the screen.

21. The apparatus of claim 18, wherein, after the moving of the selected menu icon to the selected sphere region, the menu setting unit displays the moved menu icon on the screen.

22. The apparatus of claim 21, wherein the menu setting unit displays the menu icon on the screen together with the effect that the menu icon flies from the sphere displayed on the screen.

23. The apparatus of claim 18, wherein the menu setting unit generates a new region if the user touches an empty region in the sphere displayed on the screen.

24. The apparatus of claim 18, wherein the menu setting unit:
provides an edit function for at least one of menu generation, menu change and menu deletion if the user requests one of menu generation, menu change and menu deletion with respect to a region of the sphere; and
executes the menu icon if the user requests the execution of the menu icon.

25. The apparatus of claim 18, wherein the menu setting unit displays the menu icon included in the sphere region by using a sweep function if the number of menu icons included in the sphere region is greater than the maximum number of menu icons displayable on one screen.

26. The apparatus of claim 18, wherein the menu setting unit rotates the sphere displayed on the screen according to another touch input of the user while maintaining the touch input of the user for selecting the menu icon on the screen.

27. An apparatus for managing a menu icon on one screen in a portable terminal, the apparatus comprising:
a display unit for providing a screen display; and
a menu setting unit for selecting a menu icon through a screen touch input of a user, for moving the selected menu icon to the outside of a sphere displayed on the screen according to the touch input of the user, for rotating the sphere displayed on the screen according to the touch input of the user, for selecting a sphere region, into which the menu icon is to move, through a screen touch input of the user, and for moving the selected menu icon to the selected sphere region.

28. The apparatus of claim 27, wherein, before the selecting of the menu icon through the screen touch input of the user, the menu setting unit selects the sphere region including the selected menu icon through the touch input of the user in the sphere displayed on the screen, and displays at least one menu icon included in the sphere region including the selected menu icon on the screen.

29. The apparatus of claim 28, wherein the menu setting unit displays the at least one menu icon on the screen together with the effect that the menu icon flies from the sphere displayed on the screen.

30. The apparatus of claim 27, wherein, after the moving of the selected menu icon to the selected sphere region, the menu setting unit displays the moved menu icon on the screen.

31. The apparatus of claim 30, wherein the menu setting unit displays the menu icon on the screen together with the effect that the menu icon flies from the sphere displayed on the screen.

32. The apparatus of claim 27, wherein the menu setting unit generates a new region if the user touches an empty region in the sphere displayed on the screen.

33. The apparatus of claim 27, wherein the menu setting unit:
provides an edit function for at least one of menu generation, menu change and menu deletion if the user requests one of menu generation, menu change and menu deletion with respect to a region of the sphere; and
executes the menu icon if the user requests the execution of the menu icon.

34. The apparatus of claim 27, wherein the menu setting unit displays the menu icon included in the sphere region by using a sweep function if the number of menu icons included in the sphere region is greater than the maximum number of menu icons displayable on one screen.

35. A method for displaying a menu icon on one screen of a portable terminal, the method comprising:
determining, by a menu setting unit, whether a region is selected from a sphere of a first screen portion; and
displaying, by a display unit, if the region is selected, at least one menu icon included in the selected region in a second screen portion.

36. The method of claim 35, wherein the displaying of the at least one menu icon included in the selected region in the second screen portion comprises:
displaying the at least one menu icon together with the effect that the menu icon flies from the region of the first screen portion to the second screen portion.

37. An apparatus for displaying a menu icon on one screen of a portable terminal, the apparatus comprising:
a display unit for providing a screen display; and
a menu setting unit for determining whether a region is selected from a sphere of a first screen portion, and for displaying, if the region is selected, at least one menu icon included in the selected region in a second screen portion.

38. The apparatus of claim 37, wherein the menu setting unit displays the at least one menu icon together with the effect that the menu icon flies from the region of the first screen portion to the second screen portion.
